(19) United States
(12) Patent Application Publication
(10) Pub. No.: US 2005/0090731 A1
(43) Pub. Date: Apr. 28, 2005

(54) SYSTEM AND METHOD TO REMOTELY GENERATE ACTIVATION KEY AND SCRIPT FOR REMOTE ACTIVATION OF SOFTWARE-BASED OPTION

(76) Inventors: Michael R. Minogue, Milwaukee, WI (US); Geoffrey S. Christanday, Milwaukee, WI (US); Esmeraldo R.V. Davantes, Pewaukee, WI (US); Winnie C. Durbin, Dousman, WI (US); Kun Zhang, Waukesha, WI (US)

Correspondence Address: ZIOLKOWSKI PATENT SOLUTIONS GROUP, SC (GEMS), 14135 NORTH CEDARBURG ROAD, MEQUON, WI, 53097, US

(21) Appl. No.: 10/605,803

(22) Filed: Oct. 28, 2003

(51) Int. Cl. H04L 9/00

(52) U.S. Cl. 600/407; 709/219; 713/200

(57) ABSTRACT

A system and method are provided to remotely activate options resident on a device includes generating an activation key configured to activate an option resident in a memory of an in-field device and selecting a verification script to at least confirm enableability of the option in the in-field device. The invention also includes sending the activation key and the verification script to the in-field device wherein the in-field device is capable of executing the verification script and receiving a report from the in-field device. If the report is satisfactory, the activation key is installed in the in-field device whereby the option is activated and if the report is not satisfactory, activation of the option is aborted.

### BACKGROUND OF INVENTION

The present invention relates generally to a system to enable software-based options, and more particularly, to remotely verify the status of a remote device and, if the remote device is approved, activate a desired option.

Medical diagnostic devices and supporting systems, such as medical imaging systems, have become increasingly complex in recent years. Examples of such systems include magnetic resonance imaging (MRI) systems, computed tomography (CT) systems, ultrasound and x-ray systems, and positron emission tomography (PET) systems. These systems include many different software-based options, some of which are not used depending on customer needs and costs. To add to the complexity of each particular imaging system, many facilities today incorporate a variety of such devices all of which may not be configured identically. In larger facilities, the systems may be networked to permit common management and control. Further, such systems may be networked with a picture archiving and communication system (PACS) for storing digitized image data for subsequent retrieval and reconstruction. Additionally, teleradiology systems that involve transmitting digitized image data to remote locations for review and diagnosis by specialized physicians and/or radiologists may be used as well.

Because these medical diagnostic systems are used by different facilities with differing needs, not all of these systems operate identically. That is, although identical software may be installed at the factory, certain options are not desired or licensed by a customer or user, and therefore are not enabled when delivered. If a customer later wants to add these options to their devices, a license must be executed and service personnel with appropriate training must physically travel to the location where the device is present to enable the software in order for the customer to gain access to a particular option.

Improvements in computer networks have greatly facilitated the task of offering assistance to remote facilities with medical imaging devices. In particular, rather than having to call a service center and speak with a technician or engineer, or await the arrival of a field engineer, network technologies have facilitated proactive techniques wherein the service center may contact the medical diagnostic devices directly to check the status of the remote devices.

While such advancements in the provision of remote services to medical diagnostic devices have greatly enhanced the level of service and information exchange, they have not been used to remotely verify the status of an in-field device, grant access to and permit use of software options resident on the in-field device.

There is a need for a system where a qualified customer can access a particular option already resident in memory of a device without requiring multiple levels of human interaction to ensure that enabling the particular option is possible and can be implemented without impairing the usability of the device.

It would therefore be desirable to have a system to automatically verify the current status of a device requesting access to a particular option and then, if the current status of the device is such that activation of the particular option is appropriate, automatically activate the particular option.

### BRIEF DESCRIPTION OF INVENTION

The present invention is directed to a system and method to automatically respond to a request for activation of an option resident on a remote device that overcomes the aforementioned drawbacks. The invention is designed to automatically verify the status of the remote device and, if the remote device is in condition for activation, automatically activate the desired option.

The present invention includes a method to remotely activate options resident on a device. The method includes generating an activation key configured to activate an option resident in memory of an in-field device and selecting a verification script to at least confirm enableability of the option in the in-field device. The method also includes sending the activation key and the verification script to the in-field device wherein the in-field device is capable of executing the verification script, and receiving a report from the in-field device. If the report is satisfactory, the method includes installing the activation key in the in-field device whereby the option is activated and if the report is not satisfactory, the method includes aborting activation of the option.

The present invention includes a system to respond to a request to remotely enable an option resident on an in-field device including a centralized facility located remotely from an in-field device having an inactive option. The centralized facility has at least one computer programmed to select a verification script to check that the in-field device is in condition to activate the inactive option and send the verification script to the in-field device wherein the in-field device is capable of executing the verification script. The computer is further programmed to install an activation key in the in-field device to activate the inactive option if the verification script indicates that the in-field device is in condition to activate the inactive option.

The present invention also includes a system to remotely enable an option resident on an in-field device that includes an in-field device located remotely from a centralized facility. The in-field device is programmed to send an access request to the centralized facility to request activation of an option of an in-field device and then receive an activation key uniquely configured to activate the option of the in-field device and a verification script to authenticate a current status of the in-field device. The in-field device is programmed to send a report generated by the verification script to the centralized facility indicating the current status of the in-field device and install the activation key to activate the option if the current status of the in-field device is determined to be satisfactory by the centralized facility.

Various other features, objects and advantages of the present invention will be made apparent from the following detailed description and the drawings.

### BRIEF DESCRIPTION OF DRAWINGS

The drawings illustrate a preferred embodiment as presently contemplated for carrying out the invention.

In the drawings:

FIG. 1 is a block diagram of a system for which the present invention is implemented therein.

FIG. 2 is a flow chart showing a process of the present invention and implemented in the system of FIG. 1.

### DETAILED DESCRIPTION

The present invention is directed to a technique to automatically verify a current status of an in-field device and, if the device is in proper condition, activate an inactive option of the device.

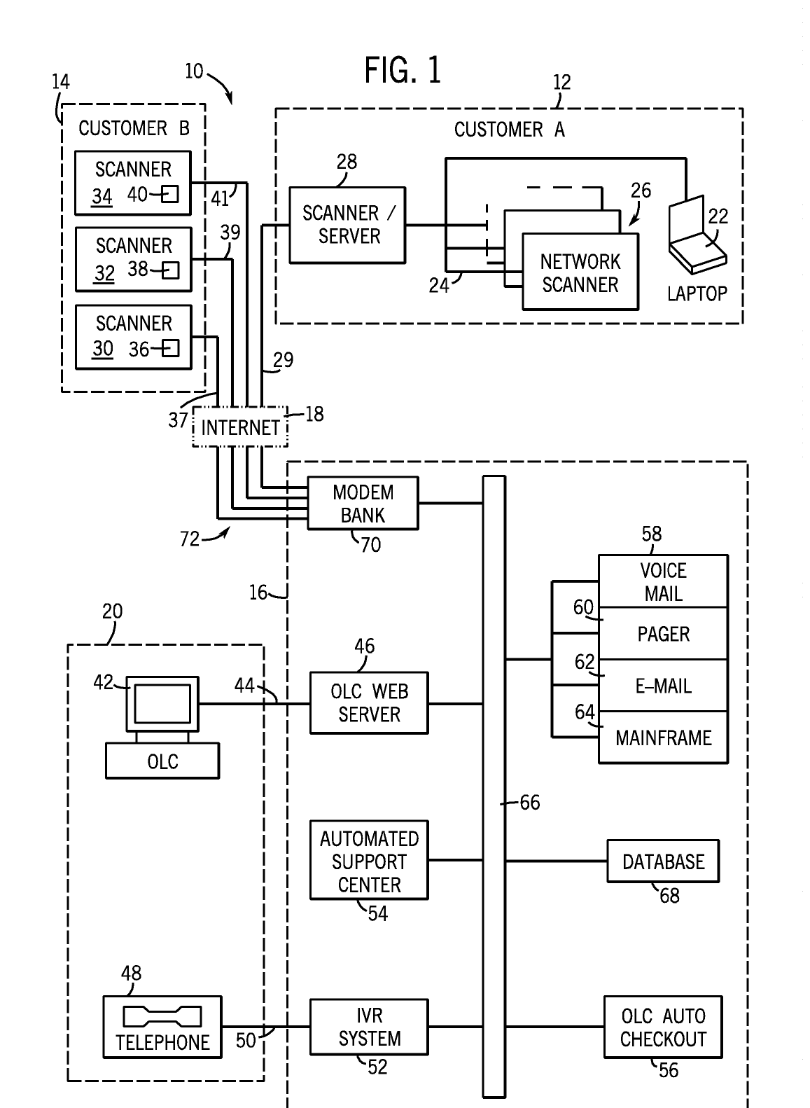

Referring to FIG. 1, an overview block diagram of a medical diagnostic and service networked system 10 is shown which includes a plurality of remote customer stations, such as Customer A in a customer station 12 and Customer B in another customer station 14. It is understood, that the number of customer stations can be limitless, but two specific embodiments are shown with Customer A and Customer B, which will be further explained hereinafter. The customer stations 12, 14 are connected to a centralized facility 16 through a communications link, such as a network of interconnected server nodes/Internet 18 or a remote link 20. Although a single centralized facility 16 is shown and described, it is understood that the present invention contemplates the use of multiple centralized facilities, each capable of communication with each customer station. Each customer station has operational software associated therewith which can be configured, serviced, maintained, upgraded, monitored, enabled or disabled by the centralized facility 16.

The various systems disclosed are configured to be selectively linked to the centralized facility 16 by either the remote link 20, or in the example of customer station 12, a laptop computer 22 connected to an internal network 24 of Customer A. Such selective linking is desirable to provide upgrades, maintenance, service, and general monitoring of the various systems and equipment at a customer site, which includes accessing data from the systems and transmitting data to the systems, for example.

In general, a customer site may have a number of devices such as a variety of medical diagnostic systems of various modalities. As another example, in the present embodiment, the devices may include a number of networked medical image scanners 26 connected to an internal network 24 served by a single scanner 28 having a workstation configured to also act as a server, or configured as a stand-alone server without a medical image scanner associated therewith. Alternately, a customer station, or customer site 14 can include a number of non-networked medical image scanners 30, 32, and 34 each having a computer or work station associated therewith and having an internal modem 36, 38, and 40 to connect the remote customer station to a communications link, such as the Internet 18 through links 37, 39, and 41, respectively, to communicate with the centralized facility 16. Internet 18 is shown in phantom to indicate that an external communications network can include Internet 18, together with communication links 29, 37, 39, and 41, or alternatively, can include direct dial-up links through dedicated lines, an intranet, or public communications systems.

It is understood that each of the network scanners 26 has its own workstation for individual operation and are linked together by the internal network 24 so that the customer can have a centralized management system for each of the scanners. Further, such a system is provided with communications components allowing it to send and receive data over a communications link 29. Similarly, for the non-networked medical image scanners at remote customer station 14, each of the scanners 30, 32, and 34 have individual communications links 37, 39, and 41. Although FIG. 1 shows each of these links connected through an open network 18, these links can permit data to be transferred to and from the systems over a dedicated network as well.

The embodiment shown in FIG. 1 contemplates a medical facility having such systems as magnetic resonance imaging (MRI) systems, ultrasound systems, x-ray systems, computed tomography (CT) systems, as well as positron emission tomography (PET) systems, or any other type of medical imaging system, however, the present invention is not so limited. Such facilities may also provide services to centralized medical diagnostic management systems, picture archiving and communications systems (PACS), teleradiology systems, etc. Such systems can be either stationary and located in a fixed place and available by a known network address, or be mobile having various network addresses. In the embodiment shown in FIG. 1, each customer station 12, 14 can include any combination of the aforementioned systems, or a customer station may have all of a single type of system. A customer station can also include a single medical image scanner. Mobile diagnostic systems can be configured similarly to that of customer station 12 or customer station 14. Such mobile diagnostic systems can include equipment of various modalities, such as MRI, CT, ultrasound, or x-ray systems and are mobilized in order to service patients at various medical facilities.

A request for access and enablement of software-based options of the present invention can be initiated by authorized personnel, such as an on-line engineer or technician, or customer administrative personnel from a computer or workstation 42 in the remote link 20, which can be a part of the centralized facility 16, or be separately connected to the centralized facility 16 by a dialup link 44 to a web server 46 in the centralized facility 16. Alternatively, it is contemplated that the system could be initialized by a laptop computer 22 connected to a customer internal network 24, or individually connected to each of the scanners 30, 32, or 34. The remote link 20 can also serve to connect the centralized facility 16 to a customer station by a telephone and telephone connection 48 through a conventional telephone network 50 and to an interactive voice recognition system (IVR) 52 in the centralized facility 16. The centralized facility 16 includes a number of processing systems including computers for the IVR system 52, an automated support center 54, the web server 46, and an auto checkout server 56, for processing customer and product data and creating an appropriate configuration file. Other processor systems include computers to maintain a voicemail system 58, a pager system 60, an email system 62, and a main frame 64, and more generally, an output report generator and notifier. Each is connectable and can transmit data through a network, such as an Ethernet 66 with one another, and/or with at least one database 68. However, it is understood that the single representation of a database in FIG. 1 is for demonstrative purposes only, and it is assumed that there is a need for multiple databases in such a system. It is also understood that the IVR system is not only a voice recognition system, but can also process interactive keypad entry from a touchtone telephone 48. A bank of modems 70 is connected to the Ethernet 66 to relay data from the centralized facility 16 to the remote customer stations 12, 14 through a plurality of modem links 72. Hence, a system to allow automatic remote transfer of data and communications between the centralized facility 16 and a customer site 12, 14 is provided.

As previously discussed, each of the systems and substations described herein and referenced in FIG. 1 may be linked selectively to the centralized facility 16 via a network 18. According to the present invention, any acceptable network may be employed whether public, open, dedicated, private, or so forth. The communications links to the network may be of any acceptable type, including conventional telephone lines, fiber optics, cable modem links, digital subscriber lines, wireless data transfer systems, or the like. Each of the systems is provided with communications interface hardware and software of generally known design, permitting them to establish network links and exchange data with the centralized facility 16. The systems are provided with interactive software so as to configure the systems and exchange data between the customer stations and the centralized facility 16. In some cases, during periods when no data is exchanged between the customer stations and the centralized facility, the network connection can be terminated. In other cases, the network connection is maintained continuously.

The present invention includes a technique for reviewing a remote device for a current status, and if approved for activation, granting access to and remotely permitting use of resident software options in the remote device. As previously indicated, the device, including medical imaging equipment, includes installed software that controls options that can be enabled or disabled automatically. The present invention is directed toward a method and system to automatically and remotely access an in-field device, verify the current status of the in-field device and enable options resident on the in-field device.

From a centralized facility, and after appropriate authentication of the user and validation of the system identification and customer's status, an electronic enabler is generated in the centralized facility 16 and electronically transmitted to a device via the communication links 29, 37, 39, 41, and/or 72, preferably over a private communication link, but other public communications systems can work equally well, such as direct dial-up internet, or wireless communications. As previously set forth, it is understood that the external communications links include a closed intranet system, an open public communications system, or a combination thereof.

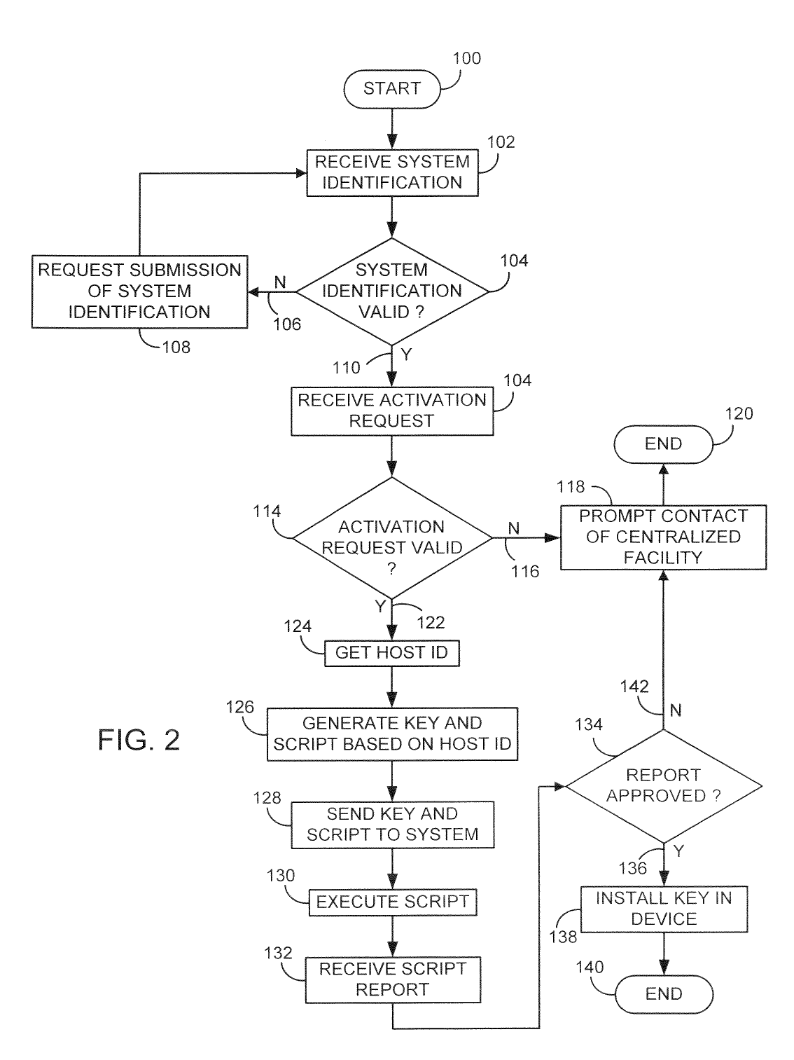

Referring to FIG. 2, the technique is initiated 100 when a system identification including a customer identification is sent from a remote customer station or a remote link and received at the centralized facility 102. It is contemplated that the system identification constitutes the initiation of an enablement request. That is, the requesting device may have been originally purchased having a plurality of options and, due to pricing considerations, the device was purchased with some of the options initially disabled. Therefore, the initial purchase of the hardware of the device included a wide variety of options and the customer may have chosen that specific options be disabled to reduce the overall purchase price of the device. Accordingly, after purchase, the customer may make an enablement or activation request to enable any of the options resident on the device at the time of purchase but disabled due to pricing choices. It is further contemplated that the activation request may be to enable options added after the initial purchase as part of an update or upgrade but disabled to reduce the price of the upgrade or update.

After receiving the system identification, the centralized facility then validates the system identification at 104. Validation is determined according to the customer identification and/or a passphrase. The system identification constitutes a unique identification that enables the centralized facility to readily identify the customer making the request and the customer's in-field devices. If the customer identification is not valid 106, a prompt for entry of a valid customer identification is requested 108. After the system identification is validated 104, 110, a particular software option that is desired to be activated is sent from the in-field device requesting activation and is received at the centralized facility 112. The centralized facility then validates the activation request at 114. Specifically, the centralized facility makes an initial review of the activation request by comparing the system identification to the activation request. The centralized facility determines whether the system is capable of the activation requested. For example, the centralized facility determines whether the requested activation has previously been made and fulfilled, and therefore, the option is already enabled.

If the activation request 112 is determined to be invalid 116, e.g., the requested option is already active in the device or does not register the requesting in-field device as including or supporting the software-based option requested, a message is returned to the in-field device to prompt manual contact with the centralized facility 118 and the activation is aborted 120.

However, if the activation request is determined to be valid 122, the in-field device then sends a unique host identifier to the centralized facility 124. The unique host identifier indicates to the centralized facility, the specific in-field device where activation is requested. Based on the host ID, the centralized facility generates an activation key configured to activate the desired option upon installation in the in-field device. Furthermore, the centralized facility selects a verification script appropriate to determine a current status of the in-field device 126. Once the activation key has been generated and the verification script selected 126, the centralized facility sends the key and script to the in-field device 128. It is contemplated that script and key may be sent to the in-field device in a single transmission or through multiple transmissions. Furthermore, if a single transmission is made, the key and script may be bundled together to create a single package that is sent to the in-field device. It is further considered that the single package may be compressed and/or encrypted to expedite and secure transmission.

When the in-field device receives the key and script, the device unbundles the package, if necessary, and executes the verification script 130. The verification script is configured to automatically determine a current status of the in-field device requesting option activation. Specifically, the verification script gathers a plurality current settings of the in-field device and generates a report. For example, the verification script may determine which options are currently active on the in-field device, which options are supported by the in-field device, any dependencies of options supported by the in-field device as well as other similar settings. The report contains information regarding the enableability of the in-field device with respect to the requested option. That is, the information included in the report pertains to the current setting of the in-field device and whether, under those settings, the in-field device is in condition to have the requested option enabled, i.e. the enableability of the in-field device. The information is then used by the verification script to generate a report that is sent by the in-field device and received by the centralized facility 132. The centralized facility then evaluates the report 134 to determine the enableability of the in-field device with respect to the requested option.

If the report indicates the device is enableable, the report is approved 136 and the centralized facility permits installation of the activation key in the in-field device 138. Specifically, the centralized facility sends an approval to the in-field device whereby the in-field device installs the activation key enabling the option 138 and the activation of the option is complete 140. However, the centralized facility may monitor the use of the option. As such, the activation key may contain a preset expiration time, whereby the centralized facility may warn the customer of an impending expiration. Should the customer elect to reactivate the option, the steps described above are repeated and the option is reactivated.

However, if the report indicates that the desired option cannot readily be activated, the centralized facility does not approve the report 142. Accordingly, a message is returned to the in-field device to prompt manual contact with the centralized facility 118 and the activation is aborted 120.

Accordingly, the present invention includes a method to remotely activate an option resident in the memory of an in-field device without compromising the functionality of the in-field device.

In accordance with one embodiment, a method to remotely activate options resident on a device includes generating an activation key configured to activate an option resident in a memory of an in-field device and selecting a verification script to at least confirm enableability of the option in the in-field device. The method further includes sending the activation key and the verification script to the in-field device wherein the in-field device is capable of executing the verification script and receiving a report from the in-field device. If the report is satisfactory, the method includes installing the activation key in the in-field device whereby the option is activated and if the report is not satisfactory, the method includes aborting activation of the option.

In accordance with another embodiment of the current invention a system to respond to a request to remotely enable an option resident on an in-field device includes a centralized facility located remotely from an in-field device having an inactive option. The centralized facility has at least one computer programmed to select a verification script to check that the in-field device is in condition to activate the inactive option and send the verification script to the in-field device wherein the in-field device is capable of executing the verification script. The computer is further programmed to install an activation key in the in-field device to activate the inactive option if the verification script indicates that the in-field device is in condition to activate the inactive option.

In accordance with another embodiment of the current invention a system to remotely enable an option resident on an in-field device that includes an in-field device located remotely from a centralized facility. The in-field device is programmed to send an access request to the centralized facility to request activation of an option of an in-field device and then receive an activation key uniquely configured to activate the option of the in-field device and a verification script to authenticate a current status of the in-field device. The in-field device is programmed to send a report generated by the verification script to the centralized facility indicating the current status of the in-field device and install the activation key to activate the option if the current status of the in-field device is determined to be satisfactory by the centralized facility.

The present invention has been described in terms of the preferred embodiment, and it is recognized that equivalents, alternatives, and modifications, aside from those expressly stated, are possible and within the scope of the appending claims.

1. An automated method of remotely activating options resident on a device comprising the steps of:
generating an activation key configured to activate an option resident in a memory of an in-field device;
selecting a verification script to at least confirm enableability of the option in the in-field device;
sending the activation key and the verification script to the in-field device wherein the in-field device is capable of executing the verification script;
receiving a report from the in-field device; and
if the report is satisfactory, installing the activation key in the in-field device whereby the option is activated and if the report is not satisfactory, aborting activation of the option.

2. The method of claim 1 further comprising the step of generating the activation key to be unique to the in-field device.

3. The method of claim 1 further comprising the step of bundling the activation key and the verification script together and wherein the step of sending the activation key and the verification script to the in-field device includes sending the bundle.

4. The method of claim 1 further comprising the step of selecting the verification script such that the report is automatically generated when executed by the in-field device.

5. The method of claim 4 wherein the step of selecting includes selecting the verification script to provide the report including at least one of:
options currently active;
options supported by the in-field device; and
dependencies of options supported by the in-field device.

6. The method of claim 5 further comprising the step of determining, from the report, whether the option to be activated is one of currently active, not supported by the in-field device, and requires dependent activations and, if the determination is positive, deeming the report unsatisfactory.

7. The method of claim 6 further comprising the step of sending a message prompting contact with a centralized facility if the report is unsatisfactory.

8. The method of claim 1 further comprising the step of monitoring use of the option an providing a warning of an expiration of the activation key.

9. The method of claim 1 further comprising the step of generating the activation key upon receiving an access request from the in-field device at a centralized facility.

10. The method of claim 9 further comprising the step of receiving a system ID as part of the access request, wherein the system ID is a unique identifier of a customer initiating the access request.

11. The method of claim 10 further comprising the step of verifying whether the access request and system ID are valid.

12. The method of claim 1 wherein the in-field device is configured for medical imaging.

13. A system to respond to a request to remotely enable an option resident on an in-field device, the system comprising:
a centralized facility located remotely from an in-field device having an inactive option, and the centralized facility having at least one access computer programmed to:
select a verification script to check that the in-field device is in condition to activate the inactive option;
send the verification script to the in-field device wherein the in-field device is capable of executing the verification script; and
install an activation key in the in-field device to activate the inactive option if the verification script indicates that the in-field device is in condition to activate the inactive option.

14. The system of claim 13 wherein the computer is further programmed to generate an activation key upon receipt of an access request from the in-field device.

15. The system of claim 14 wherein the activation key is based upon a unique host ID received from the in-field device.

16. The system of claim 15 wherein the computer is further programmed to electronically transmit the activation key to the in-field device to active the inactive option.

17. The system of claim 13 wherein the in-field device is in condition to activate the inactive option if the in-field device supports the inactive option and dependent configuration is unnecessary to activate the inactive option.

18. The system of claim 17 wherein the computer is further programmed to receive a report automatically generated by the verification script from the in-field device indicating whether the in-field device supports the inactive option and whether dependent configuration is necessary to activate the inactive option.

19. The system of claim 13 wherein the computer is further programmed to send a notification to contact the centralized facility if the in-field device is not in condition to activate the inactive option.

20. The system of claim 13 wherein the in-field device is a medical imaging device.

21. A system to remotely enable an option resident on an in-field device, the system comprising:
an in-field device located remotely from a centralized facility and programmed to:
send an access request to the centralized facility to request activation of an option of the in-field device;
receive an activation key uniquely configured to activate the option of the in-field device and a verification script to authenticate a current status of the in-field device;
send a report generated by the verification script to the centralized facility indicating the current status of the in-field device; and
install the activation key to activate the option if the current status of the in-field device is determined to be satisfactory by the centralized facility.

22. The system of claim 21 wherein the activation key is based upon a host ID unique to the in-field device.

23. The system of claim 21 wherein a message prompting communication with the centralized facility is sent to the in-field device if the current status of the in-field device is unsatisfactory.

24. The system of claim 23 wherein the current status of the in-field device is unsatisfactory if the report indicates that at least one of: the option is currently active, the in-field device does not support the option, and absent dependencies preclude activation of the option.

25. The system of claim 21 wherein the activation key and the verification script are received as a bundle.

26. The system of claim 25 wherein the bundle is compressed.

27. The system of claim 21 wherein the in-field device is a medical imaging device.

28. The system of claim 21 wherein the report includes at least one of:
options currently active;
options supported by the in-field device; and
dependencies of options supported by the in-field device.

29. The system of claim 21 wherein the in-field device is determined to be satisfactory if the option is enableable in the in-field device.
